(19) United States
(12) Patent Application Publication
(10) Pub. No.: US 2013/0311259 A1
(43) Pub. Date: Nov. 21, 2013

(54) SYSTEMS AND METHODS FOR ACQUIRING NEW CUSTOMERS

(71) Applicants: Brian Kleinberg, Short Hills, NJ (US); Jocelyn Lee, New York, NY (US); Jeffrey Reiser, Brooklyn, NY (US); Ariel Steinlauf, Brooklyn, NY (US); Robin Thiessen, New York, NY (US)

(72) Inventors: Brian Kleinberg, Short Hills, NJ (US); Jocelyn Lee, New York, NY (US); Jeffrey Reiser, Brooklyn, NY (US); Ariel Steinlauf, Brooklyn, NY (US); Robin Thiessen, New York, NY (US)

(73) Assignee: American Express Travel Related Services Company, Inc., New York, NY (US)

(21) Appl. No.: 13/473,399

(22) Filed: May 16, 2012

(51) Int. Cl. G06Q 30/02; G06Q 30/06

(52) U.S. Cl. 705/14.16; 705/14.4; 705/14.73

(57) ABSTRACT

Systems, methods, and articles of manufacture for acquiring new customers. A plurality of merchants may submit customer lists to a business acquisition coalition (BAC). The BAC may combine the customer lists to create a master customer list. A merchant may transmit a customer offer to the BAC. The BAC may create an offer list comprising customers that meet criteria of the customer offer. The BAC may remove customers from the offer list which were provided by the merchant. The BAC may transmit the customer offer to the customers on the offer list. A customer may purchase the customer offer. The BAC may transmit payment to the merchant, and transmit a commission to a providing merchant that provided the customer's information. The BAC may receive an acquisition fee from the merchant.

### BACKGROUND

1. Field

This disclosure generally relates to acquiring new customers, and more particularly, to acquiring new customers by distributing offers to consumers without cannibalizing customer lists.

2. Related Art

Businesses attempt many methods to attract new customers. The methods often include promotions or coupons offered to customers. However, it may be difficult to target the appropriate customer base. It also may be difficult to distinguish between new customers and existing customers.

Some businesses offer daily deal coupons, in which a website may provide its users with a voucher for purchase which may be used at a particular merchant. However, existing customers of the merchant may purchase the voucher, thus typically resulting in existing customers paying less for goods or services they would have purchased without the voucher. This is referred to as cannibalization of the customer base.

Additionally, many businesses typically maintain customer databases. However, they may not be obtaining the maximum value out of the information they contain, or they may not be able to share the information without breaching privacy policies or laws, Thus, a need exists to leverage customer databases to attract new customers without cannibalization of existing customers, while protecting privacy concerns.

### SUMMARY

The present disclosure includes systems, methods, and articles of manufacture for targeting offers to customers. The method may comprise combining a plurality of merchant customer lists comprising customer entries into a master customer list. The master customer list may be enriched with third party data. The method may comprise removing duplicate entries from the master customer list. A customer offer may be received from a merchant. The method may comprise creating an offer list by selecting customer entries from the master customer list based on criteria provided by a first merchant to create selected customer entries. The method may comprise removing customer entries provided by the first merchant from the selected customer entries. A customer offer associated with the first merchant may be transmitted to customers on the offer list corresponding to the selected customer entries. A voucher may be transmitted to a customer that purchases the customer offer.

The method may further comprise receiving payment for the customer offer. The payment may be transmitted to the merchant. An acquisition fee may be received from the merchant. The method may comprise transmitting a commission to a providing merchant that provided information relating to the customer to the master customer list.

### BRIEF DESCRIPTION OF THE DRAWINGS

The features and advantages of the disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an environment in which target offer module may be deployed, according to various embodiments of the disclosure;

FIG. 2A is an implementation of the target offer module for acquiring new customers, according to various embodiments;

FIG. 2B is an implementation of a system for acquiring new customers, according to various embodiments;

FIG. 3 is a flowchart illustrating a process for targeting new customers, according to various embodiments;

FIG. 4 is a flowchart illustrating a process for processing payments, according to various embodiments;

FIG. 5 is a block diagram of an exemplary computer system, according to various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

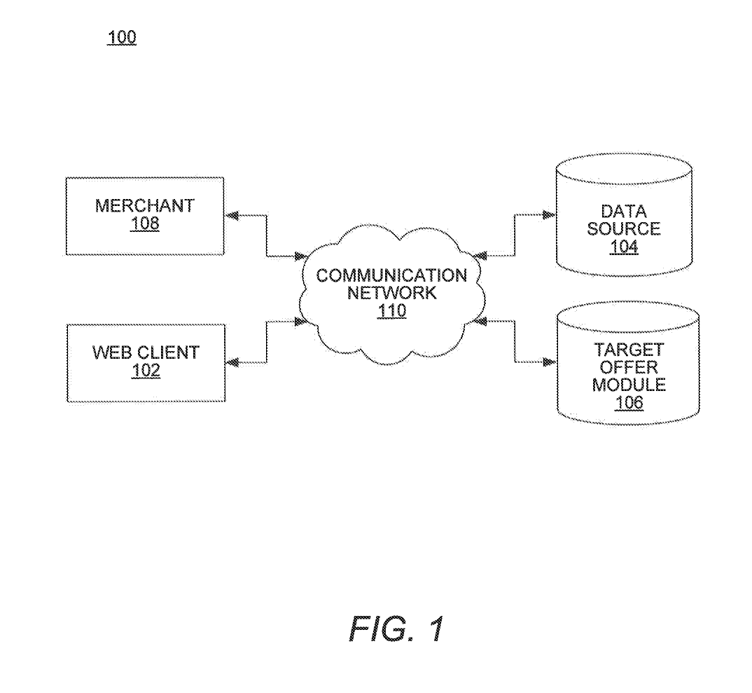

Referring to FIG. 1, a system 100 is illustrated according to various embodiments of the disclosure. A customer may, communicate with network 110 via a web client 102. Web client 102 may include any device (e.g., personal computer) which communicates via any network, for example such as those discussed herein. Web client 102 may comprise a browser application. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internee.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

System 100 may include a merchant 108. Phrases and terms similar to “business” or “merchant” may be used interchangeably with each other and shall mean any person, entity, distributor system, software and/or hardware that is a provider, broker and/or any other entity in the distribution chain of goods or services. For example, merchant 108 may be a grocery store, a retail store, a travel agency, a service provider, an on-line merchant or the like. Merchant 108 may comprise a computer, a server, a database, software, and/or hardware. Merchant 108 may be capable of storing and transmitting customer lists. Merchant 108 may be capable of creating and transmitting a customer offer. System 100 may comprise a plurality of merchants 108.

System 100 may include data source 104. Data source 104 may be controlled by a third-party. Data source 104 may contain customer information in a database. Data source 104 may comprise a computer, a server, a database, software, and/or hardware. Data source 104 may supplement customer information provided by merchant 108.

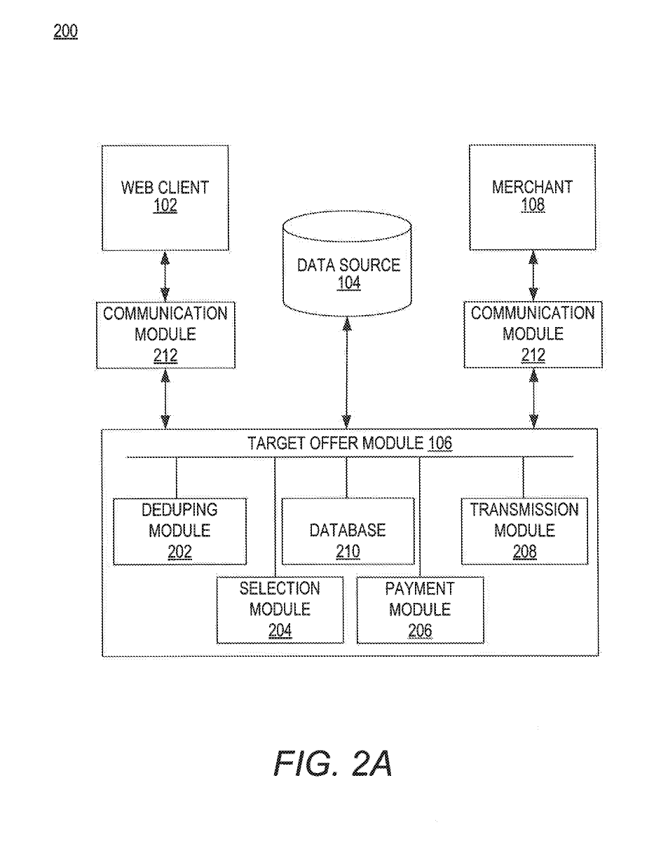

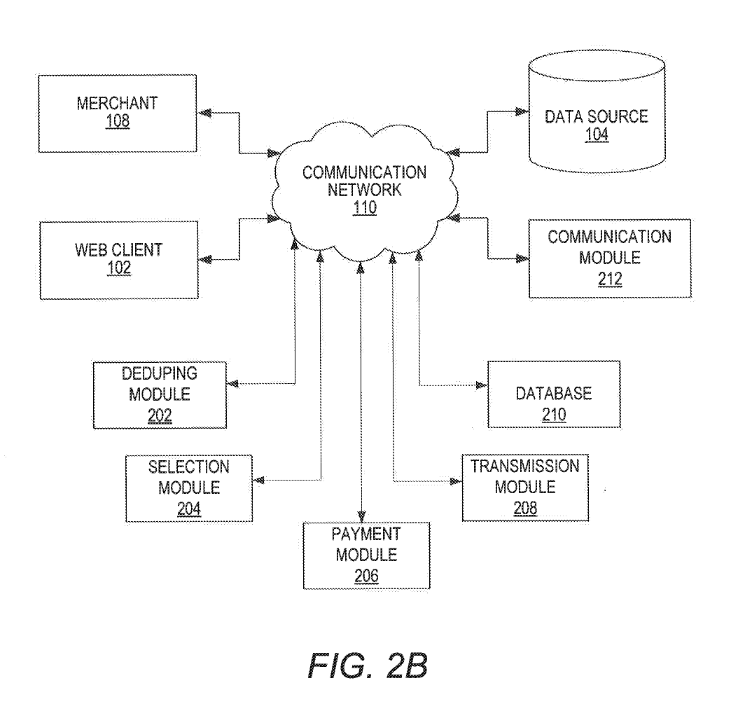

System 100 may include target offer module 106. Target offer module 106 may be controlled by a business acquisition coalition (BAC). In various embodiments, target offer module 106 may be controlled by a third party. Target offer module 106 is further described with reference to FIG. 2.

The various system components may communicate via network 110. Network 110 may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line, communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network 110 via data links which include, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby, incorporated by reference. It is noted that the network may be implemented as other types of networks, such as an interactive television (ITV) network. Moreover, the system contemplates the use, sale or distribution of any goods, services or information over any network having similar functionality described herein.

Referring to FIG. 2A, a system 200 is disclosed according to various embodiments. Target offer module 106 may comprise de-duping module 202, selection module 204, payment module 206, transmission module 208, and database 210. De-duping module 202 may receive multiple merchant customer lists. De-duping module 202 may eliminate duplicate customer entries from the master customer list. De-duping module may communicate with data source 104 to append additional data to the master customer list.

Selection module 204 may receive criteria from merchant 108 for a customer offer. Selection module 204 may evaluate the master customer list and determine which customers meet the criteria. Selection module 204 may create an offer list of customers that meet the criteria. Selection module 204 may remove customers that were submitted by merchant 108 from the offer list.

Payment module 206 may be capable of receiving, storing, and transmitting payments. Payment module 206 may authorize transaction requests. Payment module 206 may communicate with a payment processor in order to process payments. Payment module 206 may transmit payments to merchant 108.

Transmission module 208 may transmit customer offers to web client 102. Transmission module 208 may communicate with various components of system 200 via network 110.

Database 210 may store information for target offer module 106. For example, database 210 may store customer entries received from merchant 108. Database 210 may store de-duplified customer lists as well as the master customer list. Database 210 may store records of payments and fees made from and received by the BAC. Database 210 may be comprised of any combination of hardware and/or software, and databases are further described herein.

In various embodiments, target offer module 106 may communicate with web client 102 and/or merchant 108 via communication modules 212. Communication module 212 may be any device capable of interfacing between the various system components. For example, communication module 212 may be a server. The server may provide a website which may be viewed by the web client 102 or the merchant 108, allowing customers and merchants to interact with target offer module 106. In various embodiments, communication module 212 may be part of target offer module 106.

Referring to FIG. 2B, the various modules of target offer module 106 may be operated by entities other than the BAC. Any or all modules may be operated by entities other than the BAC. For example, deduping module 202 may be a third-party module capable of eliminating duplicate entries stored on database 210. Practitioners skilled in the art will appreciate that the operations performed by target offer module 106 may be performed by any combination of different entities. As illustrated in FIG. 2B, each module may be operated by a separate entity, and the various modules may communicate via communication network 110.

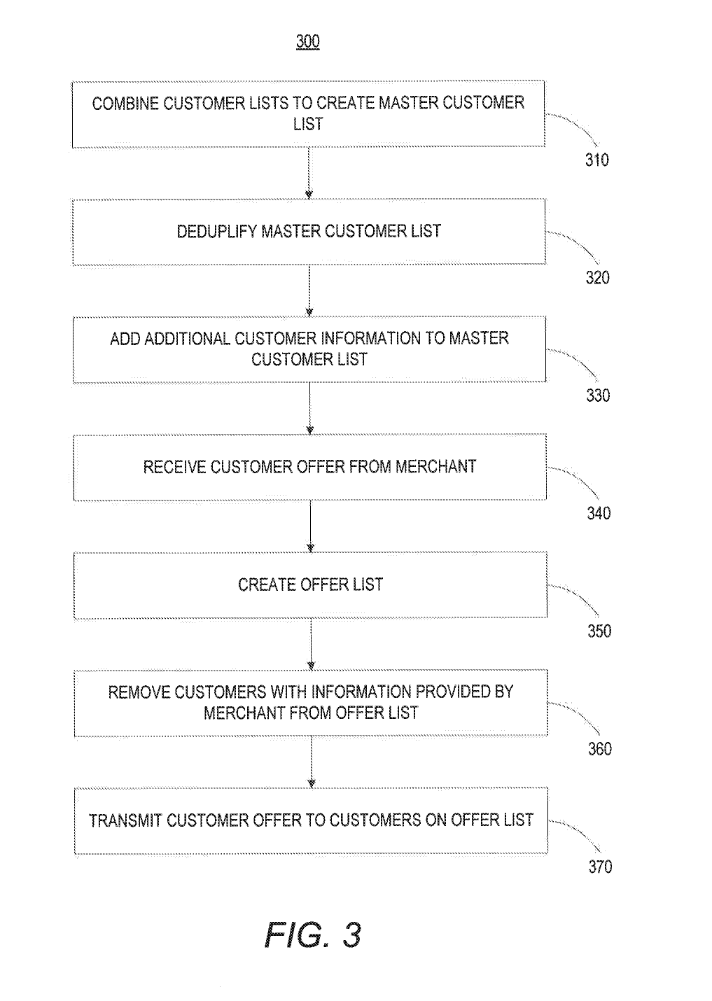

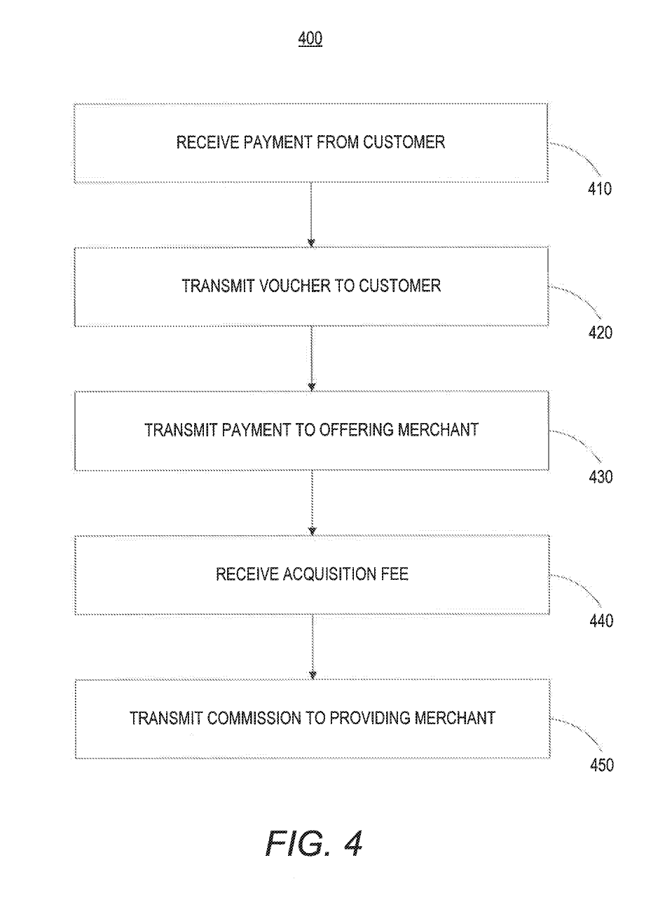

Referring now to FIGS. 3-4 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 3-4, but also to the various system components as described above with reference to FIGS. 1 and 2.

Referring to FIG. 3, a process 300 for targeting offers is illustrated according to various embodiments. Various merchants may maintain customer lists. The customer lists may be obtained by a variety of ways. A merchant may retain information about a customer when business is transacted with the customer. For example, when a customer makes a purchase from the merchant, the merchant may retain information related to the purchase such as a customer name, customer address, email address, ship-to address, the items purchased, and the amount spent. The merchant may also obtain customer information from third parties, for example by purchasing customer information. Customers may also enter customer information on a merchant website or by responding to mail or email offers. Many other methods for obtaining customer information are available and are consistent with the present disclosure.

A merchant may transmit a customer list to a business acquisition coalition (BAC). The BAC may combine customer lists from a plurality of merchants in order to create a master customer list (step 310). The master customer list may be a combination of customer lists from the merchants that participate in the BAC. The BAC may store the customer lists in a database. The BAC may de-duplicate the merchant customer lists in order to insure that multiple entries do not exist in the master customer list for a single customer (step 320). Many methods of de-duplification exist, such as eliminating multiple entries for the same customer name, service establishment number, Tax ID, or business address. In various embodiments, the customers may have the option to opt-in to the master customer list or opt-out at any time. In various embodiments, the BAC may offer an incentive to a customer to opt-in, such as a discount at one of the merchants or on a voucher.

The BAC may add additional information to the master customer list (step 330). The BAC may maintain its own customer information, and add the customer information to the information obtained from the merchant customer lists. The BAC may request customer information from third parties to enhance the master customer list. For example, the BAC may obtain additional customer information from credit reporting agencies, such as EQUIFAX or EXPERIAN. The additional customer information may be added to the master customer list in order to provide the most complete profile of each customer as possible.

In various embodiments, the merchants may not provide email addresses of the customers. The privacy policies of the merchants may prevent them from doing so. The merchants may provide other information about the customers. The BAC may compare the data in the master customer list provided by the merchants with internal data maintained by the BAC, or with third party data. The BAC may match the customer information from the merchants with the internal or third-party data and add customer email addresses to the master customer list. As such, the BAC may be able to communicate with the customers via email without the merchants divulging customer email addresses.

The BAC may create a unique customer identification for each customer in the master customer list. The unique customer identification may comprise a number, such that privacy information for the customers is protected. Thus, each customer entry in the master customer list may comprise a number, past transaction information, geographic region, and business demographic information, such as number of employees, type of business, and financial information. Additionally, the BAC may track which merchant provided information regarding a specific customer.

A merchant may transmit a customer offer to the BAC (step 340). The offer may be targeted to potential customers. The customer offer may comprise customer terms, such as if the customer purchases the offer for $50, the customer may be entitled to $100 worth of goods or services from the merchant. Additionally, the customer offer may comprise distribution terms. The merchant may not wish to make the offer to all customers in the master customer list. The merchant may indicate that the customer offer is only to be distributed to customers who meet certain criteria. The criteria may comprise any information that is available in the master customer list. For example, the merchant may indicate that the customer offer should be distributed to all customers who are located in a specific geographic area and have a minimum number of employees, or to all customers who are in a particular field of business. For example, the merchant may indicate that the customer offer should be distributed to all customers who are Certified Public Accountants in Texas.

The BAC may create an offer list by selecting customer entries corresponding to customers who meet the criteria of the customer offer (step 350). The BAC may remove all customers with information provided by the merchant from the offer list (step 360). In various embodiments, the BAC may remove all customers with information provided by the merchant prior to creating the offer list.

In various embodiments, the BAC may notify the merchant of the number of customers on the offer list. The merchant may decide to modify the criteria, in order to create an over list with the desired number of customers. The merchant may transmit modified criteria to the BAC, and the BAC may create a modified offer list.

In various embodiments, the merchant may not have access to information contained in the master customer list. Therefore, the merchant may not have access to any customer information which the merchant did not provide. Thus in order to send customer offers to the customers, the merchant may use the BAC to transmit the customer offers on the merchant's behalf.

The BAC may transmit the customer offer to all customers on the offer list (step 370). The customer offer may be transmitted by any method known in the art. For example, the customer offer may be transmitted by email, mail, telephone call, or text message. The customer offer may be available on an offer website, such that in response to accessing the offer website, the customer may view all customer offers available to them. In various embodiments, the customer offer may be emailed to the customer from a merchant email account. In various embodiments the BAC may email the customers from the merchant email account, such that the email appears to be originated by the merchant. In various embodiments, the BAC may provide the merchant with encrypted email addresses for the customers, such that the merchant may email the customer offer to the customers, however the merchant may not obtain the actual email addresses of the consumers.

In various embodiments, a providing merchant that provides customer information to the BAC may not share email addresses of customers in their customer list with the BAC due to privacy concerns. However, the merchant may share other information about a customer such as the business type and transaction history. The BAC may determine that customers from the providing merchant in the master customer list meet the criteria for a customer offer from an offering merchant. The BAC may instruct the providing merchant to email the customer offer to the customers on behalf of the offering merchant. As such, the offering merchant may be able to send targeted offers to customers on the providing merchant's customer list without the providing merchant divulging the email addresses of its customers to the offering merchant or the BAC.

Referring to FIG. 4, a process 400 for managing payments of the customer offer is illustrated according to various embodiments. In various embodiments, the customer may purchase the customer offer from the BAC (step 410). The customer may purchase the customer offer using any payment method known in the art. For example the customer may enter transaction account information on the offer website and submit a transaction request to the BAC. The customer may have previously registered with the BAC, and the BAC may transmit a bill to the customer. In the previous example, the customer may submit a transaction request to the BAC for $50 in order to receive $100 worth of merchant credit.

The BAC may provide a voucher to the customer (step 420). The voucher may contain information indicating that the customer has purchased the customer offer. The voucher may be emailed to the customer such that the customer may print the voucher and present the voucher to the merchant. The customer may display the offer to the merchant on a portable device, such as a smart phone. The voucher may comprise a voucher code, such that the consumer presents the voucher code to the merchant in order to redeem the customer offer. In various embodiments, the BAC may transmit voucher information to the merchant, such that the merchant may store the voucher information in a merchant database. In response to the customer engaging in a financial transaction with the merchant, the merchant may determine that the customer has purchased the customer offer and automatically apply the customer offer to the customer's financial transaction. In various embodiments, the BAC may store the voucher information, such that, in response to the customer using a transaction account for a financial transaction with the merchant, the BAG may credit the customer's transaction account for the value of the voucher.

In various embodiments, the BAG may receive the purchase amount of the customer offer from the customer. The BAC may transmit the purchase amount to the merchant (step 430). The BAC may receive an acquisition fee from the merchant (step 440). The merchant may transmit the acquisition fee in response to receiving the purchase amount from the BAG. However, in various embodiments the merchant may transmit the acquisition fee to the BAC in response to the customer redeeming the voucher.

The acquisition fee may be a percentage of the purchase amount, a flat fee, a combination of a flat fee and a percentage, or any other amount. In various embodiments, the acquisition fee may comprise a royalty on future customer purchases. For example, the acquisition fee may comprise an initial flat fee or percentage of the voucher. The acquisition fee may comprise a percentage of all future customer purchases, or a flat fee for each future customer purchase. In various embodiments the acquisition fee may comprise a time-based fee, wherein the merchant pays the BAC a fixed amount per given time-period for as long as the customer is a customer of the merchant. In various embodiments, the royalty portion of the acquisition fee may diminish over time. For example, the acquisition fee may comprise 10% of customer purchases from the merchant for the first month, 5% of customer purchases for the second month, 2% for the third month, etc.

In various embodiments the merchant may transmit the acquisition fee to the BAC in response to each customer purchase. However, the merchant may track the acquisition fees for a plurality of purchases by the customer and transmit the total acquisition fee for the customer to the BAC periodically. Additionally, the merchant may combine the acquisition fees for a plurality of customers and transmit the combined acquisition fees to the BAC periodically.

In various embodiments, the BAC may transmit all or a portion of the purchase amount to the merchant. The BAC may withhold the acquisition fee from the purchase amount. The acquisition fee may be a flat fee. The acquisition fee may be a percentage of the purchase amount. The percentage may be anywhere from 0% to 100% of the purchase amount, in various embodiments, the BAC may transmit the merchant share of the purchase amount to the merchant in response to receiving the purchase amount from the customer. In various embodiments the BAC may transmit the merchant share in response to determining that the customer has redeemed the voucher with the merchant. In various embodiments, the BAC may transmit the full purchase amount to the merchant, and in response to the customer redeeming the voucher, the merchant may transmit the acquisition fee to the BAC.

In various embodiments, the BAC may determine which merchant provided information related to the customer for the customer list. The BAC may transmit a commission to the merchant that provided the customer information (step 450). The commission may be a flat fee, a percentage of the purchase amount, a percentage of the acquisition fee, or any other amount. The commission may be transmitted in response to receiving the purchase amount from the consumer. In various embodiments, the commission may be transmitted in response to determining that the customer has redeemed the voucher. In various embodiments, the BAC may store the commission and transmit all commissions earned in a time period, such as a month, to the providing merchant at the end of the time period in a lump payment.

In various embodiments, the BAC may determine that multiple merchants have provided information related to the customer for the customer list. The BAC may distribute the commission amongst the providing merchants in any way. For example, the BAC may transmit the entire commission to the first merchant that provided the customer information. The BAC may divide the commission equally between each merchant that provided the customer information. The BAC may divide the commission between the providing merchants according to the amount or quality of the customer information provided.

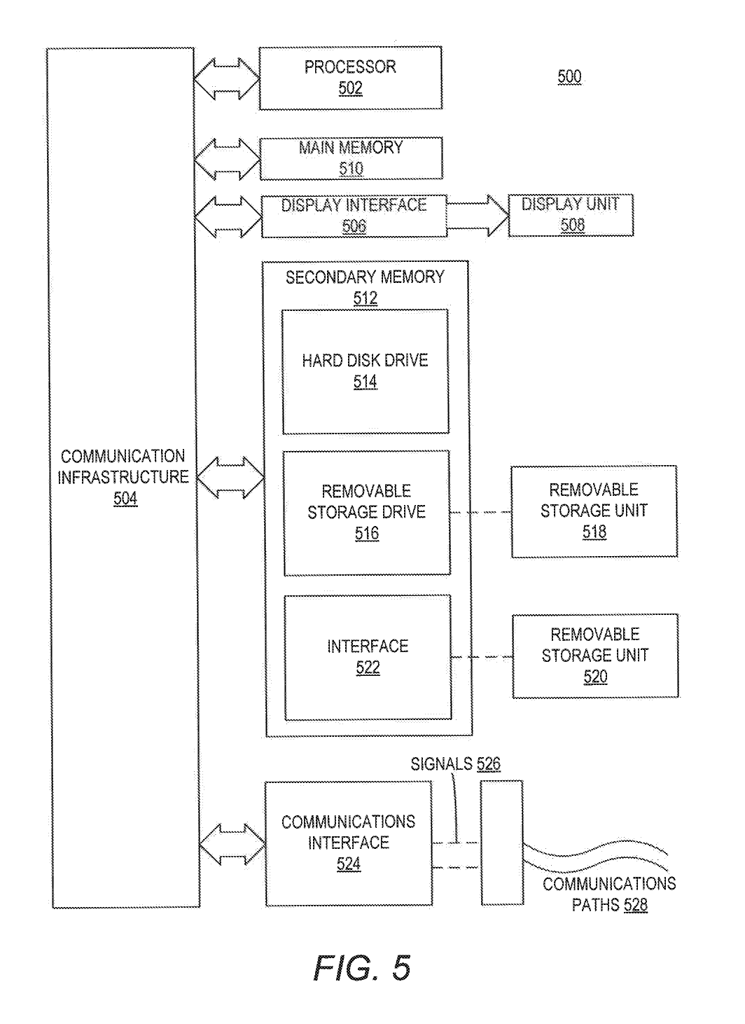

Referring to FIG. 5, in accordance with various embodiments of the present system, the present system is directed towards one or more computer systems capable of carrying out the functionality described herein.

The computer system 500 includes at least one processor, such as a processor 502. Processor 502 is connected to a communication infrastructure 504, for example, a communications bus, a cross over bar, a network, and the like. Various software embodiments are described in terms of this exemplary computer system 500. After reading this description, it will become apparent to a person skilled in the relevant art(s) how to implement the system using other computer systems and/or architectures.

The computer system 500 includes a display interface 506 that forwards graphics, text, and other data from the communication infrastructure 504 for display on a display unit 508.

The computer system 500 further includes a main memory 510, such as random access memory (RAM), and may also include a secondary memory 512. The secondary memory 512 may further include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a well known manner. The removable storage unit 518 may represent a floppy disk, magnetic tape or an optical disk, and may be read by and written to by the removable storage drive 516. As will be appreciated, the removable storage unit 518 includes a computer usable storage medium having stored therein, computer software and/or data.

In accordance with various embodiments of the system, the secondary memory 512 may include other similar devices for allowing computer programs or other instructions to be loaded into the computer system 500. Such devices may include, for example, a removable storage unit 520, and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units 520 and interfaces 522, which allow software and data to be transferred from the removable storage unit 520 to the computer system 500.

The computer system 500 may further include a communication interface 524. The communication interface 524 allows software and data to be transferred between the computer system 500 and external devices. Examples of the communication interface 524 include, but may not be limited to a modem, a network interface (such as an Ethernet card), a communications port, a Personal Computer Memory Card International Association (PCMCIA) slot and card, and the like. Software and data transferred via the communication interface 524 are in the form of a plurality of signals, hereinafter referred to as signals 526, which may be electronic, electromagnetic, optical or other signals capable of being received by the communication interface 524. The signals 526 are provided to the communication interface 524 via a communication path (e.g., channel) 528. The communication path 528 carries the signals 526 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 516, a hard disk installed in hard disk drive 514, the signals 526, and the like, These computer program products provide software to the computer system 500, The disclosure is directed to such computer program products.

Computer programs (also referred to as computer control logic) are stored in the main memory 510 and/or the secondary memory 512, Computer programs may also be received via the communication interface 504. Such computer programs, when executed, enable the computer system 500 to perform the features of the disclosure, as discussed herein. In particular, the computer programs, when executed, enable the processor 502 to perform the features of the disclosure. Accordingly, such computer programs represent controllers of the computer system 500.

In accordance with various embodiments, where the system is implemented using a software, the software may be stored in a computer program product and loaded into the computer system 500 using the removable storage drive 516, the hard disk drive 514 or the communication interface 524. The control logic (software), when executed by the processor 502, causes the processor 502 to perform the functions of the system as described herein.

In various embodiments, the system may be implemented primarily in hardware using, for example, hardware components such as application specific integrated circuits (ASIC). Implementation of the hardware state machine so as to perform the functions described herein will be apparent to persons skilled in the relevant art(s).

In various embodiments, the system is implemented using a combination of both the hardware and the software.

In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with various embodiments, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The phrases consumer, customer, user, account holder, cardmember or the like shall include any person, entity, government organization, business, machine associated with a transaction account, buys merchant offerings offered by one or more merchants using the account and/or who is legally designated for performing transactions on the account, regardless of whether a physical card is associated with the account. For example, the cardmember may include a transaction account owner, an transaction account user, an account affiliate, a child account user, a subsidiary account user, a beneficiary of an account, a custodian of an account, and/or any other person or entity affiliated or associated with a transaction account.

In various embodiments, the methods described herein are implemented using the various particular machines described herein. The methods described herein may be implemented using the described particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

In various embodiments, the server may include application servers (e.g. WEB SPHERE, WEB LOGIC, MOSS). In various embodiments, the server may include web servers (e.g. APACHE, IIS, GWS, SUN JAVA SYSTEM WEB SERVER).

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art, For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with various embodiments, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first triple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in various embodiments, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data, including the header or trailer may be received by a stand alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, POP, PKI, GPO (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of the system to further enhance security.

Firewall may include any hardware and/or software suitably configured to protect system components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc°, may be used to provide an Active Data Object (ADO) compliant database management system. In various embodiments, the Apache web server is used in conjunction with a Linux operating system, a MySQL database, and the Peri, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, lookup tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Each participant may be equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or various embodiments combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an MID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer, Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure, is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A computer-implemented method comprising:
selecting, by a computer-based system capable of acquiring new customers, customer entries from a master customer list based on criteria provided by a first merchant to create selected customer entries, wherein the master customer list comprises customer entries provided by a plurality of merchants;
removing, by the computer-based system, customer entries provided by the first merchant from the selected customer entries; and
transmitting, by the computer-based system, a customer offer associated with the first merchant to customers corresponding to the selected customer entries.

2. The method of claim 1, further comprising enriching, by the computer-based system, the customer entries with third-party data.

3. The method of claim 1, further comprising removing, by the computer-based system, duplicate customer entries.

4. The method of claim 1, further comprising transmitting, by the computer-based system, a voucher to the customer.

5. The method of claim 1, further comprising receiving, by the computer-based system, payment for the customer offer.

6. The method of claim 5, further comprising transmitting, by the computer-based system, the payment to the first merchant.

7. The method of claim 6, further comprising receiving, by the computer-based system, an acquisition fee from the first merchant.

8. The method of claim 7, wherein the acquisition fee comprises at least one of a flat fee or a percentage of the payment.

9. The method of claim 7, wherein the acquisition fee comprises a royalty on future purchases.

10. The method of claim 9, wherein the royalty comprises a percentage which decreases over time.

11. The method of claim 5, further comprising retaining, by the computer-based system, an acquisition fee from the payment.

12. The method of claim 5, further comprising transmitting, by the computer-based system, a merchant share of the payment to the first merchant.

13. The method of claim 5, further comprising determining, by the computer-based system, that a providing merchant provided information related to the customer for the master customer list.

14. The method of claim 13, further comprising transmitting, by the computer-based system, a commission to the providing merchant.

15. The method of claim 1, wherein the transmitting comprises emailing the customer from a merchant email account.

16. The method of claim 13, further comprising instructing, by the computer-based system, the providing merchant to email the customer offer to the customer.

17. The method of claim 14, further comprising distributing, by the computer-based system, the commission to a plurality of providing merchants.

18. The method of claim 1, further comprising storing, by the computer-based system, the customer offer in a database.

19. The method of claim 18, further comprising crediting, by the computer-based system, a transaction account associated with the consumer for the value of the customer offer in response to determining that the customer has redeemed the customer offer.

20. The method of claim 5, further comprising transmitting, by the computer-based system, a merchant share to the first merchant in response to determining that the customer has redeemed the customer offer.

21. The method of claim 1, further comprising combining, by the computer-based system, a plurality of merchant customer lists to create the master customer list.

22. The method of claim 1, further comprising providing, by the computer-based system, a list of customer offers available to the customer on a website.

23. The method of claim 1, further comprising creating, by the computer-based system, a unique customer identification number for the consumer.

24. An article of manufacture including a non-transitory, tangible computer readable storage medium having instructions stored thereon that, in response to execution by a computer-based system capable of acquiring new customers, cause the computer-based system to be capable of performing operations comprising:
selecting, by the computer-based system, customer entries from a master customer list based on criteria provided by a first merchant to create selected customer entries, wherein the master customer list comprises customer entries provided by a plurality of merchants;
removing, by the computer-based system, customer entries provided by the first merchant from the selected customer entries; and
transmitting, by the computer-based system, a customer offer associated with the first merchant to customers corresponding to the selected customer entries.

25. A system comprising:
a processor capable of acquiring new customers,
a tangible, non-transitory memory configured to communicate with the processor,
the tangible, non-transitory memory having instructions stored thereon that, in response to execution by the processor, cause the processor to be capable of performing operations comprising:
selecting, by the processor, customer entries from a master customer list based on criteria provided by a first merchant to create selected customer entries, wherein the master customer list comprises customer entries provided by a plurality of merchants;
removing, by the processor, customer entries provided by the first merchant from the selected customer entries; and
transmitting, by the processor, a customer offer associated with the first merchant to customers corresponding to the selected customer entries.
